(19) United States
(12) Patent Application Publication
(10) Pub. No.: US 2016/0165062 A1
(43) Pub. Date: Jun. 9, 2016

(54) DATA/CIRCUIT CHANNEL HANDOFF FOR IP TELEPHONY NETWORK

(71) Applicant: Vonage Network, LLC, Holmdel, NJ (US)

(72) Inventors: Boaz ZEHAVI, East Jersey, NJ (US); Matthew KROKOSZ, Wall, NJ (US); Gil OSHER, Rehovot (IL)

(21) Appl. No.: 14/565,065

(22) Filed: Dec. 9, 2014

(51) Int. Cl. H04M 7/12; H04L 29/06; H04L 12/721; H04M 7/00; H04L 12/707

(52) U.S. Cl. CPC H04M 7/12; H04M 7/006; H04L 45/22; H04L 45/70; H04L 65/1006

(57) ABSTRACT

A method of operating an internet-based telephony system comprises establishing a communication between a first telephony device and a second telephony device through the internet-based telephony system. The communication at least initially comprises a first leg of the communication and a second leg of the communication, with the first leg of the communication existing between the first telephony device and the internet-based telephony system and the second leg of the communication existing between the second telephony device and the internet-based telephony system. The method further comprises receiving a connection-request message from the first telephony device; and, as a result thereof at least partially replacing a replaceable leg with a replacement leg having a different channel type than the replaceable leg. The replaceable leg is one of the first leg of the communication and the second leg of the communication, and the different channel type is either a data channel or a circuit channel.

### TECHNICAL FIELD

The technology relates to telecommunications, and in particular to Internet Protocol (IP) telephone systems that are accessible to mobile telephony devices.

### BACKGROUND

A mobile telephony device may be connected to a telephony network either by a data channel or by a circuit channel. A “circuit channel” or “circuit connection” requires dedicated point-to-point connections during a call or communication. A “data channel” or “data connection”, on the other hand, is a channel or connection in which data is carried in separate packets and routed based on a destination address included in the packets. When received, the packets are reassembled in the proper sequence. For mobile telephony devices, WiFi and WiMax as well as General Packet Radio Service (GPRS) network and Long Term Evolution (LTE) network are examples of networks or system with data channel capability.

An Internet Protocol (IP) telephony system routes various types of communications, at least in part, via data packets that are communicated in a data channel(s) over a data network. The data network is commonly the Internet. The types of communications may be, for example, telephone calls, video calls, text and video messages, and other forms of telephony and data communications. The users of the Internet Protocol (IP) telephony system typically gain access to the Internet using an Internet service provider so that they can communicate via the IP telephony system.

Some users or customers of the IP telephony system may engage in communications using telephony devices that are connected by physical lines such as cables or wires to an access point such as an internet port. Such wired telephony devices may, thanks to the services of the IP telephony system, be moved from one physical location to another physical location, but at each such physical location are physically connected in a wired manner to the respective access point.

Other users or customers of the IP telephony system may possess mobile or wireless telephony devices, such as a wireless terminal, user equipment (UE), mobile phone, smart phone, or laptop, tablet, or other device with mobile termination. When such a mobile telephony device is within coverage of an appropriate wireless network (e.g., WiFi or WiMax network) that has connection to the a data network such as the Internet, the communications involving the mobile telephony device may be handled by the IP telephony system in conjunction with the wireless network. In other words, the communications may occur wirelessly between the mobile telephony device and a wireless access point of the wireless network, with the wireless access point in turn being connected to an Internet portal. Access in this manner to the Internet portal enables the mobile telephony device to capitalize upon the service of the IP telephony system in economically routing the communications through the Internet, rather than over existing non-Internet service carriers.

When a mobile telephony device is not in range of a wireless network to gain the benefit of the IP telephony system, the mobile telephony device may instead be served by other carriers and/or services using one or more mobile radio access networks. Such mobile radio access networks typically comprise plural base stations which have both radio frequency transmitting and receiving capabilities to serve macro cells. A macro cell is essentially defined by the extent of the transmitting and receiving capabilities of the base station. The mobile telephony devices located within the cell may communicate with the radio access network through the base station (unless the customer also happens to be within range of another wireless network, such as a WiFi or WiMax wireless network or the like, and exercises the option to use the other wireless network instead of the radio access network). In some instances such a “macro” base station may be called a “radio base station”, “base station”, NodeB, eNodeB, or the like. Historically, macro base stations could participate in only circuit switched type connections. But, more recently, some macro base stations, such as those which participate in a General Packet Radio Service (GPRS) network or a Long Term Evolution (LTE) network, provide or serve packet connections, also known as data connections.

Many radio access networks allow a mobile telephony device to roam from cell to cell, either within the same radio access network and radio access technology, or between cells of differing radio access network and/or radio access technologies. Such roaming between cells and/or technologies of radio access networks typically involves an operation or procedure known as “location update”, or some similar operation. Method and apparatus for roaming are described in U.S. Pat. No. 8,600,364; U.S. patent application Ser. No. 12/987,559, filed Jan. 10, 2011; U.S. patent application Ser. No. 14/291,566, filed May 30, 2014; and U.S. patent application Ser. No. 14/333,490, filed Jul. 16, 2014, all of which are incorporated herein by reference in their entireties.

In some scenarios involving a mobile telephony device it may be advantageous to change from one channel type to another channel type. Some such scenarios inviting channel type change are those of changing network conditions. For example, in some situations a data channel may have a lower signal or more congestion (e.g., lower quality of service) than a circuit channel, and it may be desirable to change to the circuit channel. In other situations (such as a city office environment), the data channel (e.g., a channel provided via WiFi) may have superior service. Moreover, there are also scenarios in which a mobile telephony device change locations or roams (as mentioned above), with the location change or roaming resulting in either changed network conditions or different availability of channel types. One scenario is a change of network conditions or channel type availability when a communication is in progress (e.g., when the communication has already begun).

In the cellular network technology it has been known to switch an entire communication from a packet switched channel to a circuit switched channel using a technique known as circuit switched fallback. But when poor service quality over a data channel, or loss of data channel, affects a communication involving a mobile telephony device which is handled by an internet-based telephony system, there typically is no remedy and the communication must be dropped. Lack of recourse other than dropping the communication results from the fact that the internet-based telephony system relies on data connections between itself and the telephony devices participating in the communication.

### SUMMARY

In one of its aspects the technology disclosed herein concerns a method of operating an internet-based telephony system. The method comprises establishing a communication between a first telephony device and a second telephony device through the internet-based telephony system. The communication at least initially comprises a first leg of the communication and a second leg of the communication, with the first leg of the communication existing between the first telephony device and the internet-based telephony system and the second leg of the communication existing between the second telephony device and the internet-based telephony system. The method further comprises receiving a connection-request message from the first telephony device; and, as a result thereof at least partially replacing a replaceable leg with a replacement leg having a different channel type than the replaceable leg. The replaceable leg is one of the first leg of the communication and the second leg of the communication, and the different channel type is either a data channel or a circuit channel.

In an example embodiment and mode the first leg of the communication is a first data leg and the second leg is a second data leg. In such example embodiment and mode the method further comprises associating an access number for the internet-based telephony system with a parameter of the communication; receiving a circuit channel call to the access number as the connection-request message; obtaining the parameter associated with the communication; and, routing media for the communication through the replacement leg in lieu of routing the media through the replaceable leg.

In an example embodiment and mode the method further comprises establishing the communication between the first telephony device and the second telephony device through a media relay of the internet-based telephony system; and upon receiving the circuit channel call to the access number at a gateway of the internet-based telephony system, routing the media for the communication between the gateway and the media relay in lieu of routing the media through the replaceable leg.

In an example embodiment and mode the method further comprises, upon receiving the circuit channel call to the access number at the gateway, the internet-based telephony system routing media for the communication (1) between the gateway and the media relay so that the communication is at least partially carried through the circuit channel and (2) through a non-replaced one of the first data leg of the communication and the second data leg of the communication so that the communication is at least partially carried by a data channel between the media relay and one of the telephony device and the second telephony device.

In an example embodiment and mode the parameter comprises a call identifier of the communication.

In an example embodiment and mode the parameter comprises an identifier associated with the telephony device.

In an example embodiment and mode the parameter comprises an identifier associated with the second telephony device.

In an example embodiment and mode associating the access number for the internet-based telephony system with the parameter occurs before a predetermined event and receiving the circuit channel call occurs after the predetermined event, and the predetermined event comprises a network change or a low quality event.

In an example embodiment and mode wherein at least one of the first leg and the second leg is a circuit channel leg which is at least partially carried by a circuit channel. In such example mode the method further comprises, upon whichever of the first telephony device and the second telephony device is connected to the internet-based telephony system through the circuit channel leg gaining access to a data network and thus becoming a data network-eligible telephony device, providing the data network-eligible telephony device with a parameter associated with the communication; and upon receiving the connection-request message from the data network-eligible telephony device, replacing the circuit channel leg with a data channel leg between the data network-eligible telephony device and the internet-based telephony system.

In an example embodiment and mode the method further comprises establishing the communication between the first telephony device and the second telephony device through a media relay of the internet-based telephony system; and upon receiving the connection-request message from the data network-eligible telephony device, routing the media for the communication through the data channel and the media relay.

In an example embodiment and mode the connection-request message is a SIP INVITE or SIP RE-INVITE message which includes a call identifier.

In an example embodiment and mode the connection-request message is a SIP INVITE or SIP RE-INVITE message which includes an identifier of the first telephony device.

In an example embodiment and mode the connection-request message is a SIP INVITE or SIP RE-INVITE message which includes an identifier of the second telephony device.

In another of its aspects the technology disclosed herein concerns an internet-based telephony system. The internet-based telephony system comprises a processor configured to establish a communication between a first telephony device and a second telephony device through the internet-based telephony system. The communication at least initially comprises a first leg of the communication and a second leg of the communication, with the first leg of the communication existing between the first telephony device and the internet-based telephony system and the second leg of the communication existing between the second telephony device and the internet-based telephony system. The processor is also configured to receive a connection-request message from the first telephony device; and as a result thereof to replace a replaceable leg with a replacement leg having a different channel type than the replaceable leg. The replaceable leg is one of the first leg of the communication and the second leg of the communication, and the different channel type is either a data channel or a circuit channel.

In an example embodiment and mode wherein the first leg of the communication is a first data leg and the second leg is a second data leg, and the processor is further configured to associate an access number for the internet-based telephony system with a parameter of the communication. When the connection-request message is a circuit channel call to the access number, upon receiving the circuit channel call the processor is further configured to obtain the parameter associated with the communication; and route media for the communication through the replacement leg in lieu of routing the media through the replaceable leg.

In an example embodiment and mode the processor is further configured to establish the communication between the first telephony device and the second telephony device through a media relay of the internet-based telephony system; and upon receiving the circuit channel call to the access number at a gateway of the internet-based telephony system, route the media for the communication between the gateway and the media relay in lieu of routing the media through the replaceable leg.

In an example embodiment and mode upon receiving the circuit channel call to the access number at the gateway the processor is configured to route media for the communication (1) between the gateway and the media relay so that the communication is at least partially carried through the circuit channel and (2) through a non-replaced one of the first data leg of the communication and the second data leg of the communication so that the communication is at least partially carried by a data channel between the media relay and one of the telephony device and the second telephony device.

In an example embodiment and mode the parameter comprises a call identifier of the communication.

In an example embodiment and mode the parameter comprises an identifier associated with the telephony device.

In an example embodiment and mode the parameter comprises an identifier associated with the second telephony device.

In an example embodiment and mode the processor is configured to associate the access number for the internet-based telephony system with the parameter occurs before a predetermined event and to receive the circuit channel call after the predetermined event, the predetermined event comprising a network change or a low quality event.

In an example embodiment and mode wherein at least one of the first leg and the second leg is a circuit channel leg which is at least partially carried by a circuit channel, the processor is further configured to, upon whichever of the first telephony device and the second telephony device is connected to the internet-based telephony system through the circuit channel leg gaining access to a data network and thus becoming a data network-eligible telephony device, provide the data network-eligible telephony device with a parameter associated with the communication. The processor is also configured upon receiving the connection-request message from the data network-eligible telephony device, to replace the circuit channel leg with a data channel between the data network-eligible telephony device and the internet-based telephony system.

In an example embodiment and mode the processor is further configured to establish the communication between the first telephony device and the second telephony device through a media relay of the internet-based telephony system; and upon receiving the connection-request message from the data network-eligible telephony device, route the media for the communication through the data channel and the media relay.

In an example embodiment and mode the connection-request message is a SIP INVITE or SIP RE-INVITE message which includes a call identifier.

In an example embodiment and mode the connection-request message is a SIP INVITE or SIP RE-INVITE message which includes an identifier of the first telephony device. In an example embodiment and mode the connection-request message is a SIP INVITE or SIP RE-INVITE message which includes an identifier of the second telephony device.

In another of its aspects the technology disclosed herein comprises one or more methods performed in a telephony device. The method may be performed by one or more processors of the telephony device executing a software program product stored on transient instructions, such as a CoIP application.

A first such method in a telephony device may be performed when the replaceable leg is a data channel leg and the replacement leg is a circuit channel leg. The first method in the telephony device comprises participating in establishment of a communication between telephony device and a second telephony device and through an internet-based telephony system. The method further comprises the telephony device providing the internet-based telephony system with a parameter of the communication to be associated with an access number (AN) for the internet-based telephony system; obtaining an access number (AN) for the internet-based telephony system. The method further comprises, upon occurrence of a predetermined event involving an affected leg of the communication, calling the access number (e.g., using a native dialer of the telephony device) to facilitate replacement of at least a portion of the affected leg of the communication with a circuit channel connection.

A second such method in a telephony device may be performed when the replaceable leg is a circuit channel leg and the replacement leg is a data channel leg. The second method in the telephony device comprises the telephony device participating in establishment of a communication between the telephony device and a second telephony device; the telephony device obtaining a parameter associated with the communication; the telephony device determining that a data channel is available to replace the circuit channel employed for the first circuit channel leg; and, the telephony device using the parameter to participate in a connection establishment procedure wherein the circuit channel leg of the communication is replaced with a data channel leg, e.g., replacement data channel.

### BRIEF DESCRIPTION OF THE DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1 is a diagrammatic view of a communications environment including various elements which are associated with an Internet protocol (IP) telephony system operating in accordance with an example embodiment.

FIG. 2 is a diagrammatic view of various elements of computer equipment that may comprise either an IP telephony system or telephony device in accordance with example embodiments.

FIG. 3 is a diagrammatic view of a communications network comprising an Internet-based telephony system which facilitates roaming, showing location/situation of a telephony device in various roaming positions.

FIG. 4 is a diagrammatic view of a communications network comprising an Internet-based telephony system which handles a communication between two telephony devices, showing various servers and functionalities comprising an IP communication leg handoff processor.

FIG. 4A is a diagrammatic view of the communications network comprising FIG. 4 and further showing example, representative implementation acts performed for handing off a communication leg from a data channel to a circuit channel.

FIG. 4B is a diagrammatic view of the communications network comprising FIG. 4 and further showing example, representative implementation acts performed for handing off a communication leg from a circuit channel to a data channel.

FIG. 5 is a flowchart depicting basic example, representative, non-limiting acts or steps performed by IP telephony system including generic acts or steps performed by an IP communication leg handoff processor.

FIG. 5A is a flowchart depicting basic example, representative, non-limiting acts or steps performed by IP communication leg handoff processor in conjunction with a data channel to circuit channel handoff of a leg of a communication.

FIG. 5B is a flowchart depicting basic example, representative, non-limiting acts or steps performed by IP communication leg handoff processor in conjunction with a circuit channel to data channel handoff of a leg of a communication.

FIG. 6 is a schematic view of a telephony device according to an example embodiment.

FIG. 7 schematic view of an IP telephony system according to an example embodiment.

FIG. 8 is a flowchart illustrating various example, representative acts or steps that may be performed by processors of a telephony device in conjunction with the data-to-circuit handoff of a leg of a communication as illustrated in FIG. 4A.

FIG. 9 is a flowchart illustrating various example, representative acts or steps that may be performed by processors of a telephony device in conjunction with the circuit-to-data handoff of a leg of a communication illustrated in FIG. 4B.

### DETAILED DESCRIPTION

In the following description, for purposes of explanation and not limitation, specific details are set forth such as particular architectures, interfaces, techniques, etc. in order to provide a thorough understanding of the technology disclosed herein. However, it will be apparent to those skilled in the art that the technology disclosed herein may be practiced in other embodiments that depart from these specific details. That is, those skilled in the art will be able to devise various arrangements which, although not explicitly described or shown herein, embody the principles of the technology disclosed herein and are included within its spirit and scope. In some instances, detailed descriptions of well-known devices, circuits, and methods are omitted so as not to obscure the description of the technology disclosed herein with unnecessary detail. All statements herein reciting principles, aspects, and embodiments of the technology disclosed herein, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein can represent conceptual views of illustrative circuitry or other functional units embodying the principles of the technology. Similarly, it will be appreciated that any flow charts, state transition diagrams, pseudocode, and the like represent various processes which may be substantially represented in computer readable medium and so executed by a computer or processor, whether or not such computer or processor is explicitly shown.

In this description, the terms “VoIP system”, “VoIP telephony system”, “IP system” and “IP telephony system” are all intended to refer to a system that connects callers and that delivers data, text and video communications using Internet protocol data communications.

In this description references are made to an “IP telephony device” or “telephony device”. These terms are used to refer to any type of device which is capable of interacting with an IP telephony system to complete a telephone call, including but not limited to those already described above. An IP telephony device could be an IP telephone, a computer running IP telephony software, a terminal adapter which is connected to an analog telephone, or some other type of device capable of communicating via data packets. An IP telephony device could also be a cellular telephone or a portable or tablet computing device that runs a software client that enables the device to act as an IP telephone. Thus, a single device might be capable of operating as both a cellular telephone and an IP telephony device.

This description also refers to a mobile telephony device. The term “mobile telephony device” is intended to encompass multiple different types of devices. In some instances, a mobile telephony device could be a cellular telephone. In other instances, a mobile telephony device may be a mobile computing device that includes both cellular telephone capabilities and a wireless data transceiver that can establish a wireless data connection to a data network. Such a mobile computing device could run appropriate application software to conduct VoIP telephone calls via a wireless data connection. Thus, a mobile computing device, such as an Apple iPhone™, a RIM Blackberry or a comparable device running Google's Android operating system could be a mobile telephony device.

In still other instances, a mobile telephony device may be a device that is not traditionally used as a telephony device, but which includes a wireless data transceiver that can establish a wireless data connection to a data network. That is, certain devices that are not traditionally used as telephony devices may act as telephony devices once they are configured with appropriate client software. Thus, some devices that would not normally be considered telephony devices may become telephony devices or IP telephony devices once they are running appropriate software. One example would be a desktop or a laptop computer that is running software that can interact with an IP telephony system over a data network to conduct telephone calls. Another example would be a portable computing device, such as an Apple iPod Touch™, which includes a speaker and a microphone. A software application loaded onto an Apple iPod Touch™ can be run so that the Apple iPod Touch™ can interact with an IP telephony system to conduct a telephone call.

This description also refers to telephony communications (“communications”) and telephony activity. These terms are intended to encompass all types of (telephony) communications, regardless of whether all or a portion of the communications are carried in an analog or digital format. Telephony communications could include audio or video telephone calls, facsimile transmissions, text messages, SMS messages, MMS messages, video messages, and all other types of telephony and data communications sent by or received by a user. These terms are also intended to encompass data communications that are conveyed through a PSTN or VOIP telephony system. In other words, these terms are intended to encompass any communications whatsoever, in any format, which traverse all or a portion of a communications network or telephony network.

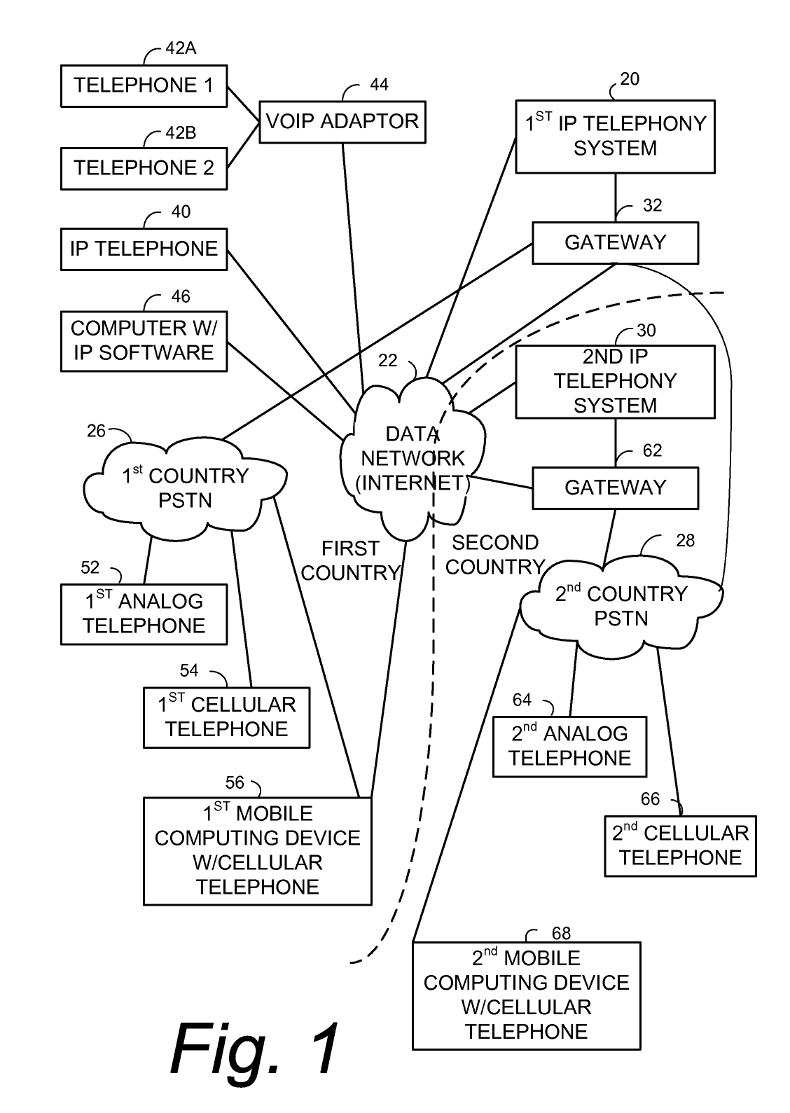

As illustrated in FIG. 1, a communications environment 18 is provided to facilitate IP based communications. A first IP telephony system 20 enables connection of telephone calls between its own customers and other parties via data communications that pass over a data network. The data network is commonly the Internet 22, however, private data networks may form all or a portion of the data communication path. The first IP telephony system 20 is connected to the Internet 22.

In addition, the first IP telephony system 20 is connected to a first publicly switched telephone network (PSTN) 26, to a second PSTN 28, and (through, e.g., data network 22) to a second IP telephony system 30. This allows the first IP telephony system 20 to receive telephony communications from and send telephony communications to each of these other communications systems. In some instances, the first IP telephony system 20 would receive an incoming communication directed to one of its own customers from one of these other communications system. The first IP telephony system 20 then terminates the call to the customer's telephony device. In other instances, the first IP telephony system may setup an outgoing call from one of its customers to a customer of one of these other communications systems. In still other instances, the first IP telephony system 20 may act as an intermediate party to connect a communication between two of these other communications systems.

In some instances, the first IP telephony system 20 accesses the Internet 22 via gateway 32. The gateway 32 allows users and devices that are connected to the first and second PSTNs 26, 28 and/or the second IP telephony system 30 to connect with users and devices that are reachable through the first IP telephony system 20, and vice versa. In some instances, the gateway 32 would be a part of the first IP telephony system 20. In other instances, the gateway 32 could be maintained by a third party.

Customers of the first IP telephony system 20 can place and receive telephone calls using an IP telephone 40 that is connected to the Internet 22. Such an IP telephone 40 could be connected to an Internet service provider via a wired connection or via a wireless router. In some instances, the IP telephone 40 could utilize a cellular telephone system to access the Internet 22.

Alternatively, a customer could utilize an analog telephone 42A which is connected to the Internet 22 via terminal adapter 44. The terminal adapter 44 converts analog signals from the telephone 42A into data signals that pass over the Internet 22, and vice versa. Also, as illustrated in FIG. 1, multiple analog telephones 42A and 42B could all be coupled to the same terminal 44. Analog telephone devices include, but are not limited to, standard telephones and document imaging devices such as facsimile machines. A configuration using a terminal adapter 44 is common where all of the analog telephones 42A, 42B are located in a residence or business, and all of the telephones are connected to the same terminal adapter. With this configuration, all of the analog telephones 42A, 42B share the same telephone number assigned to the terminal 44. Other configurations are also possible where multiple communication lines (e.g., a second telephone number) are provisioned by the IP telephony system 20.

In addition, a customer could utilize a soft-phone client running on a computer 46 to place and receive IP based telephone calls, and to access other IP telephony systems. In some instances, the soft-phone client could be assigned its own telephone number. In other instances, the soft-phone client could be associated with a telephone number that is also assigned to an IP telephone 40, or to a terminal 44 that is connected to one or more analog telephones 42A, 42B.

A third party using first analog telephone 52 which is connected to the first PSTN 26 may call a customer of the IP telephony system 20. In this instance, the call is initially connected from the first analog telephone 52 to the first PSTN 26, and then from the first PSTN 26, through the gateway 32 to the first IP telephony system 20. The first IP telephony system 20 then routes the call to the customer's IP telephony device. A third party using first cellular telephone 54 could also place a call to an IP telephony system customer, and the connection would be established in a similar manner, although the first link would involve communications between the first cellular telephone 54 and a cellular telephone network. For purposes of this explanation, the cellular telephone network is considered part of the first PSTN 26.

In addition, mobile computing devices which include cellular telephony capabilities could also be used to place telephone calls to customers of the IP telephony system. A first mobile computing device 56, as illustrated in FIG. 1, might connect to the first PSTN 26 using its cellular telephone capabilities. However, such devices might also have the ability to connect wirelessly via some other means. For example, the mobile computing device 56 might communicate with a wireless data router to connect the first mobile computing device 56 directly to a data network, such as the Internet 22. In this instance, communications between the first mobile computing device 56 and other parties could be entirely carried by data communications which pass from the first mobile computing device 56 directly to data network 22. Of course, alternate embodiments could utilize any other form of wired or wireless communications path to enable communications.

Users of the first IP telephony system 20 are able to access the service from virtually any location where they can connect to the Internet 22. Thus, a customer could register with an IP telephony system located in the United States, and that customer could then use an IP telephone located in a country outside the United States to access the services. Likewise, the customer could also utilize a computer outside the U.S. that is running a soft-phone client to access the first IP telephony system 20. Further, in some instances a user could place a telephone call with the first analog telephone 52 or first cellular telephone 54 that is routed through the first PSTN 26 to the first IP telephony system 20 via the gateway 32. This would typically be accomplished by the user calling a local telephone number that is routed to the first IP telephony system 20 via the gateway 32. Once connected to the first IP telephony system 20, the user may then place an outgoing long distance call to anywhere in the world using the first IP telephony system's network. Thus, the user is able to place a long distance call using lower cost IP telephony service provided by the first IP telephony system 20, rather than a higher cost service provided by the first PSTN 26.

FIG. 1 also illustrates that second IP telephony system 30 may interact with the first IP telephony system 20 via the Internet 22. For example, customers of the second IP telephony system 30 may place calls to customers of the first IP telephony system 20. In that instance, assets of the second IP telephony system 30 interact with assets of the first IP telephony system 20 to setup and carry the telephone call. Conversely, customers of the first IP telephony system 20 can place calls to customers of the second IP telephony system 30. The second IP telephony system could also interact with the other communications systems via gateway 62.

As illustrated in FIG. 1, the second PSTN 28 may be connected to second analog telephone 64, second cellular telephone 66, and second mobile computing device 68.

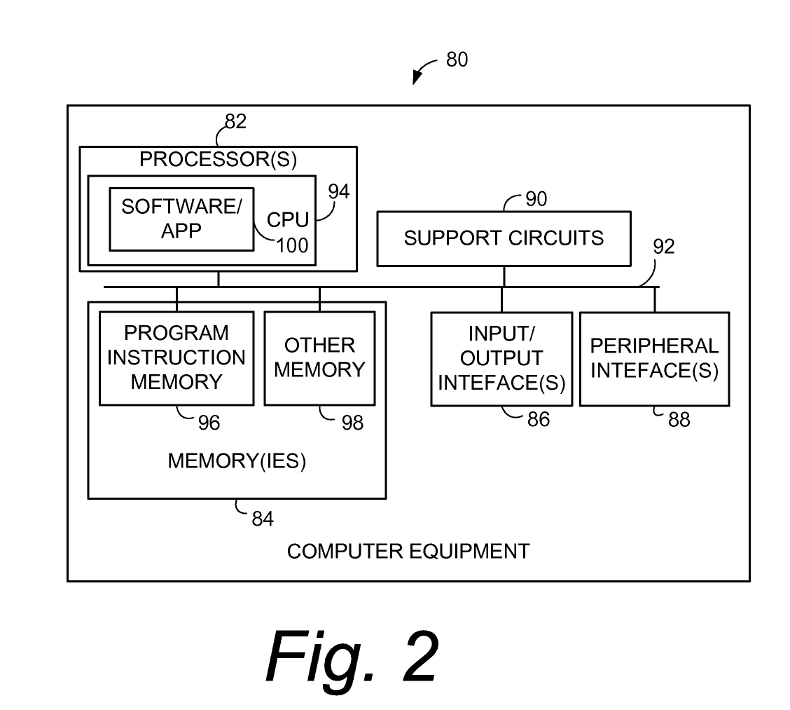

FIG. 2 illustrates elements of machine hardware 80 that may be used as part of the first or second IP telephony systems 20, 30, or as part of an IP telephony device, to accomplish various functions. In the illustrated example embodiment, the machine hardware 70 comprises a computer, e.g., computer equipment, but in other example embodiments the machine hardware 70 may instead comprise or encompass, without limitation, digital signal processor (DSP) hardware, reduced instruction set processor, hardware (e.g., digital or analog) circuitry including but not limited to application specific integrated circuit(s) [ASIC], and/or field programmable gate array(s) (FPGA(s)), and (where appropriate) state machines capable of performing such functions.

FIG. 2 shows an example of such machine hardware 80 as comprising one or more processors 82; memory(ies) 84; input/output interfaces 86; peripheral interfaces 88; support circuits 90; and buss(es) 92 for communication between the aforementioned units.

Each of the IP telephony systems 20, 30, or an IP telephony device, may include multiple processors 82, along with their operating components and programming, each carrying out a specific or dedicated function. The processor 82 shown in FIG. 2 may be one of any form of a general purpose computer processor used in accessing an IP-based network, such as a corporate intranet, the Internet or the like. The processor 82 comprises one or more central processing units (CPUs) 94.

The memory(ies) 84 may comprise memory such as program instruction memory 96 and other memory 98 (e.g., RAM, cache, etc.). The memory(ies) 84 may comprise computer-readable medium, and may be one or more of readily available memory such as random access memory (RAM), read only memory (ROM), floppy disk, hard disk, flash memory or any other form of digital storage, local or remote, and is preferably of non-volatile nature.

The support circuits 90 are coupled to the processor 82 for supporting the processor in a conventional manner. These circuits may include cache, power supplies, clock circuits, input/output circuitry and subsystems, and the like

The input/output interfaces 86 serve to connect the processor 82 to customer equipment, to service provider equipment, to IP network or gateways, as well as possibly one or more input/output devices (not shown) for accessing the processor and/or performing ancillary or administrative functions related thereto.

The buss(es) 92 may comprise plural or a single bus structure, with numerous buss configurations being possible without degrading or otherwise changing the intended operability of the processor 82.

One or more software routines or software programs are normally stored in program instruction memory 96. Some of the software routines or software programs may be referred to as “applications”. FIG. 2 shows one such software routine or software program 100 as being loaded from program instruction memory 96 into CPU 94 so that the software program 100 is executed by 94. Execution of the software program 100 causes the processor 82 to perform processes of the disclosed embodiments. The software routine 100 may also be stored and/or executed by a second CPU (not shown) that is remotely located from the hardware being controlled by the CPU 94. Also, the software routines could also be stored remotely from the CPU. For example, the software could be resident on servers and memory devices that are located remotely from the CPU, but which are accessible to the CPU via a data network connection.

The software routine 100, when executed by the CPU 94, transforms the general purpose computer into a specific purpose computer that performs one or more functions of an IP telephony system 20/30 or an IP telephony device. Although the processes of the disclosed embodiments may be discussed as being implemented as a software routine, some of the method steps that are disclosed therein may be performed in hardware as well as by a processor running software. As such, the embodiments may be implemented in software as executed upon a computer system, in hardware as an application specific integrated circuit or other type of hardware implementation, or a combination of software and hardware. The software routine 100 of the disclosed embodiments is capable of being executed on any computer operating system, and is capable of being performed using any CPU architecture.

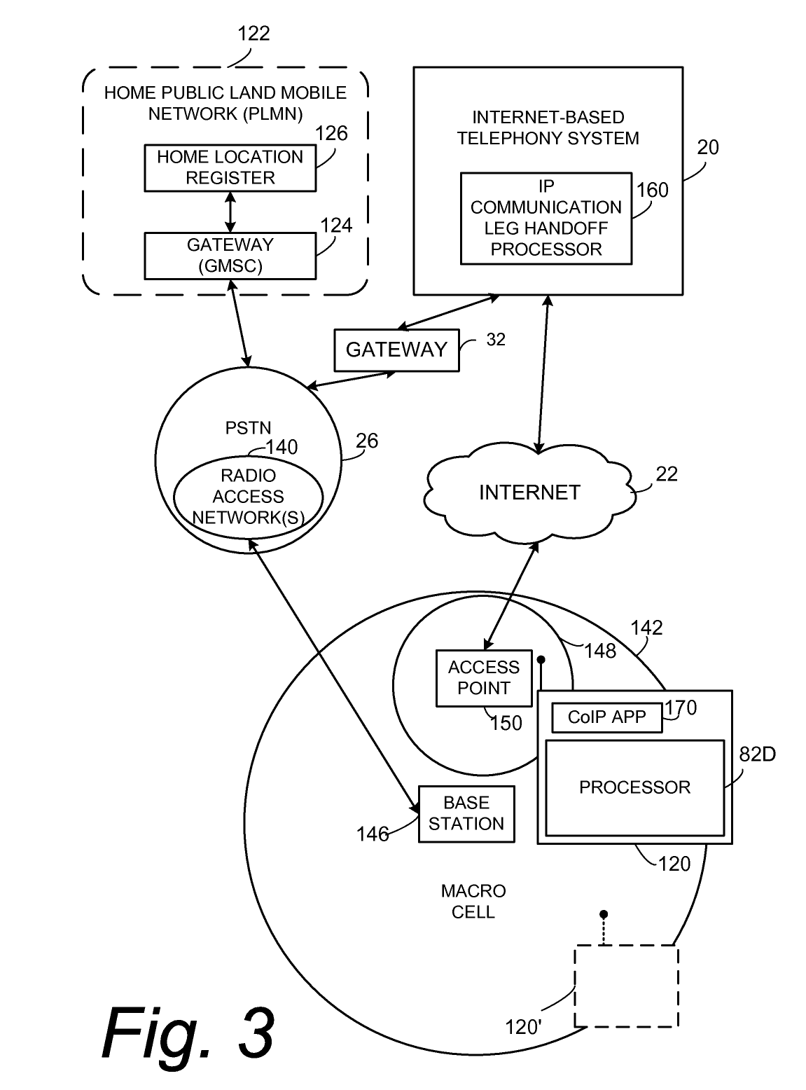

FIG. 3 again shows IP telephony system 20 being connected to a data communications network such as Internet 22. A telephony device 120, which for sake of illustration happens to be a mobile or wireless telephony device such as a user equipment unit, smart phone, or laptop with mobile termination, for example, is associated with a customer of the telephony system 20. The customer is not only a customer of telephony system 20, but is also served by the customer's home public land mobile network (PLMN) 122. The customer's home public land mobile network 122 is shown in FIG. 3 as comprising a PLMN gateway or switching center (GMSC) 124, as well as a PLMN home location register (HLR) 126.

Both home public land mobile network 122 and telephony system 20 are connected to the public switched telephone network (PSTN) 26. The public switched telephone network (PSTN) 26 may comprise one or more 26 radio access network(s) (RANs) 140. The home public land mobile network 122 is connected to public switched telephone network (PSTN) 40 through the PLMN gateway 124 (e.g., Gateway Mobile Services Switching Center [GMSC]). Telephony system 20 is also connected to public switched telephone network (PSTN) 26 through its gateway 32.

FIG. 3 further shows telephony device 120 as being situated in a radio access network cell 142 which is served by base station 146 of a radio access network 140. The base station 146 may be a base station controller (BSC), NodeB, eNodeB, or other type of base station. As such, the network cell 142 may be referred to as a macro cell and the base station 146 as a macro base station. Typically macro base stations such as macro base station 146 communicate with wireless terminals using licensed frequencies.

It will be appreciated that some macro base stations belong to networks which have data connection handling capability while other base stations belong to networks that do not have data connection handling capability. The former networks provide services such as call service and short message service (SMS), and typically include base stations which report to a radio network controller node and which may belong to a roaming area. The former networks additionally provide General Packet Radio Service (GPRS)/3G/LTE services and typically include base stations characterized as NodeB or eNodeB and for which routing areas are defined. The base stations of both types of networks broadcast their roaming and routing area.

FIG. 3 also shows telephony device 120 as being within a smaller cell 148 (e.g., a micro cell, home cell, pico cell, or femto cell) which is served by a wireless access point 150 of an internet-connected wireless access service. The access point 150 may provide Wi-Fi or WiMAX access to telephony device 120. Wi-Fi is a technology that allows an electronic device to exchange data or connect to the Internet wirelessly using microwaves in the 2.4 GHz and 5 GHz bands, and thus includes any “wireless local area network (WLAN) products that are based on the Institute of Electrical and Electronics Engineers' (IEEE) 802.11 standards” (which standards are incorporated herein by reference in entirety). The smaller cell 148 may also be referred to as an access point cell. Typically access points such as access point 150 communicate with wireless terminals using unlicensed frequencies.

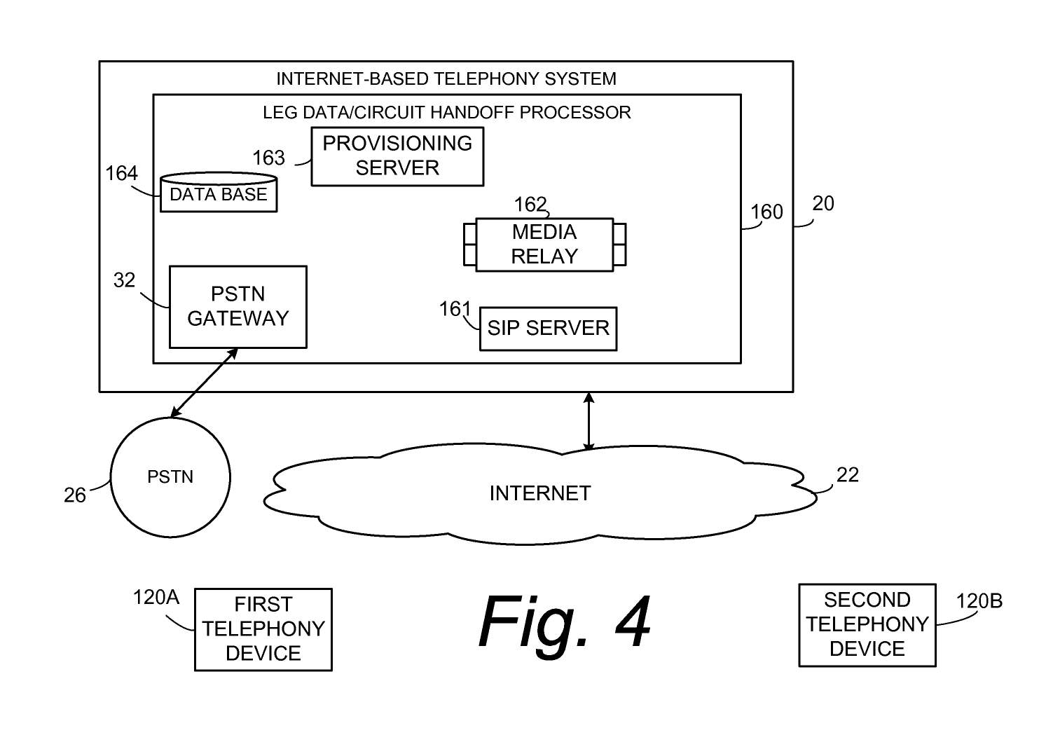

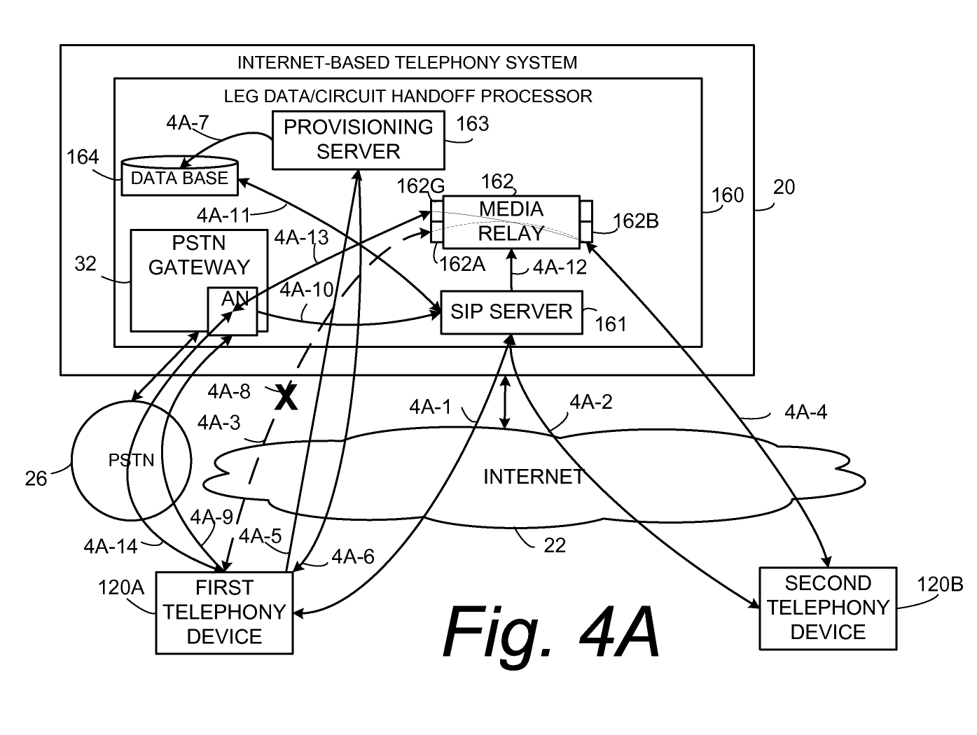

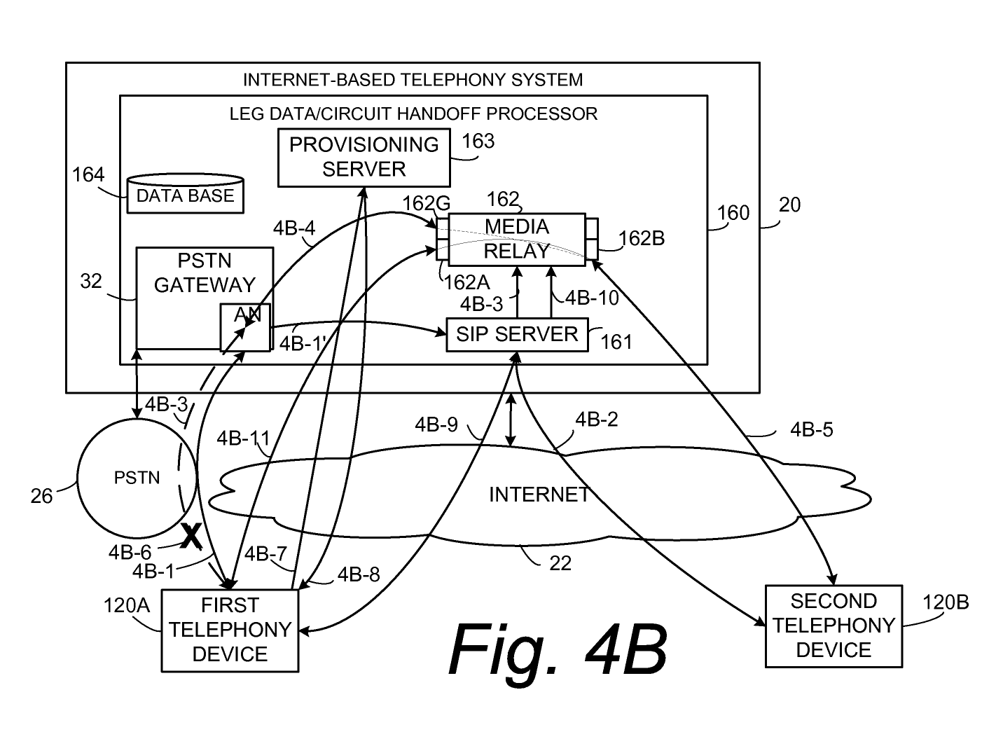

As shown in FIG. 3, telephony system 20 comprises IP communication leg handoff processor 160, also herein referred to as “leg data/circuit handoff processor”, “leg handoff processor”, “handoff processor”, and “processor”. Although phrased as a processor, IP communication leg handoff processor 160 may comprise one or more processors, controllers, or servers, either co-located or distributed, which comprise IP telephony system 20. In fact, in an example implementation of IP telephony system 20 shown in context of a network in FIG. 4, the IP communication leg handoff processor 160 comprises a session initiation protocol (SIP) server [SIP server 161], media relay server (also known as media relay 162), and provisioning server 163. These servers and other functionalities of IP telephony system 20 may communicate with one another over a data network internal to IP telephony system 20, and may have access to various other functionalities such as communication parameter database 164. The internal data network through which the servers of IP telephony system 20 communicate with one another may have an unillustrated interface, portal, or gateway to the external data network, e.g., to Internet 22. Moreover, one or more of the servers comprising IP telephony system 20 may interface with Internet 22. The IP communication leg handoff processor 160 may also connect to public switched telephone network (PSTN) 26 through gateway 32, as previously described.

An example of such an Internet-based telephony system 20 is a voice over IP (VoIP) telephony system. However, in view of the fact that the communications encompassed by the technology described herein is not limited to voice communications, the internet-based telephony system 20 may also be referred to as a “Communication over IP”, or “CoIP system”.

FIG. 4 illustrates two telephony devices, e.g., telephony device 120A and telephony device 120B. When two telephony devices engage in communications using an internet-based telephony system, the internet-based telephony system typically establishes a leg of the communication between itself and each of the two telephony devices participating in the communication. For example, for a first telephony device that may be the “calling” party (such as telephony device 120A) the internet-based telephony system may establish a first leg of the communication between itself and the first telephony device 120A, and also establish a second leg of the communication between the internet-based telephony system and a second telephony device (e.g., telephony device 120B) of the “called” party. The process of establishing the legs may occur using signaling that may be handled, e.g., by SIP server 161. The actual legs of communication, e.g., the channels which convey user data, e.g., user packets such as media packets, may be described (e.g., defined or terminated) in terms of a media relay within IP telephony system 20, such as media relay 162.

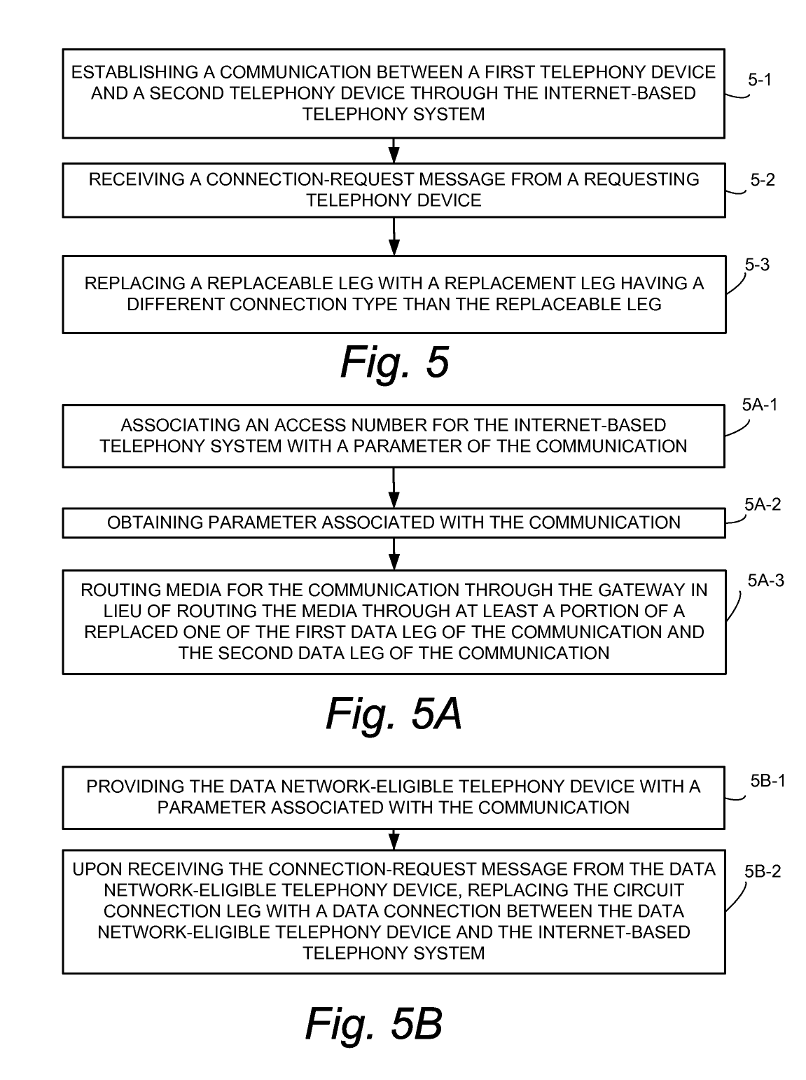

Basic example, representative, non-limiting acts or steps performed by IP telephony system 20, including acts or steps performed by IP communication leg handoff processor 160 in particular, are shown in FIG. 5. In essence, IP communication leg handoff processor 160, upon occurrence of a predetermined condition, may replace a replaceable leg of the communication with a replacement leg, and such replacement leg may be of a different channel type than the replaceable leg. For example, as subsequently described with reference to FIG. 4A and FIG. 5A, the IP communication leg handoff processor 160 may replace a data channel leg of the communication with a circuit channel leg. Alternatively, as subsequently described with reference to FIG. 4B and FIG. 5B, the IP communication leg handoff processor 160 may replace a circuit channel leg of the communication with a data channel leg. The particular condition inviting or prompting leg replacement is typically reflected by a connection request message received at the IP telephony system 20 from a telephony device 120.

Act 5-1 comprises establishing a communication between a first telephony device (e.g., telephony device 120A) and a second telephony device (e.g., telephony device 120B) through the internet-based telephony system. The communication at least initially comprises a first leg of the communication and a second leg of the communication. The first leg of the communication exists between the first telephony device 120A and the internet-based telephony system 20; the second leg of the communication exists between the second telephony device telephony device 120B and the Internet-based telephony system 20. Establishing the communication of act 5-1 typically involves the use of Session Initiation Protocol (SIP) signaling.

Act 5-2 comprises receiving another connection-request message from a requesting telephony device. The connection-request message may result based upon occurrence of a predetermined event, such as (for example) a network change or a low quality event (e.g., low quality of service). The requesting telephony device may be either the first telephony device 120A or the second telephony device 120B. The requesting telephony device may be the device that detects or is informed of the predetermined event.

Act 5-3 comprises, as a result of act 5-2, replacing a replaceable leg with a replacement leg. The replacement leg may have a different channel type than the replaceable leg. The replaceable leg is one of the first leg of the communication and a second leg of the communication, and the different channel type is either a data channel or a circuit channel. For example, act 5-3 may involve replacing a replaceable data channel first leg with a replacement circuit channel first leg; or replacing a replaceable circuit channel first leg with a replacement data channel first leg; or replacing a replaceable data channel second leg with a replacement circuit channel second leg; or replacing a replaceable circuit channel second leg with a replacement data channel second leg.

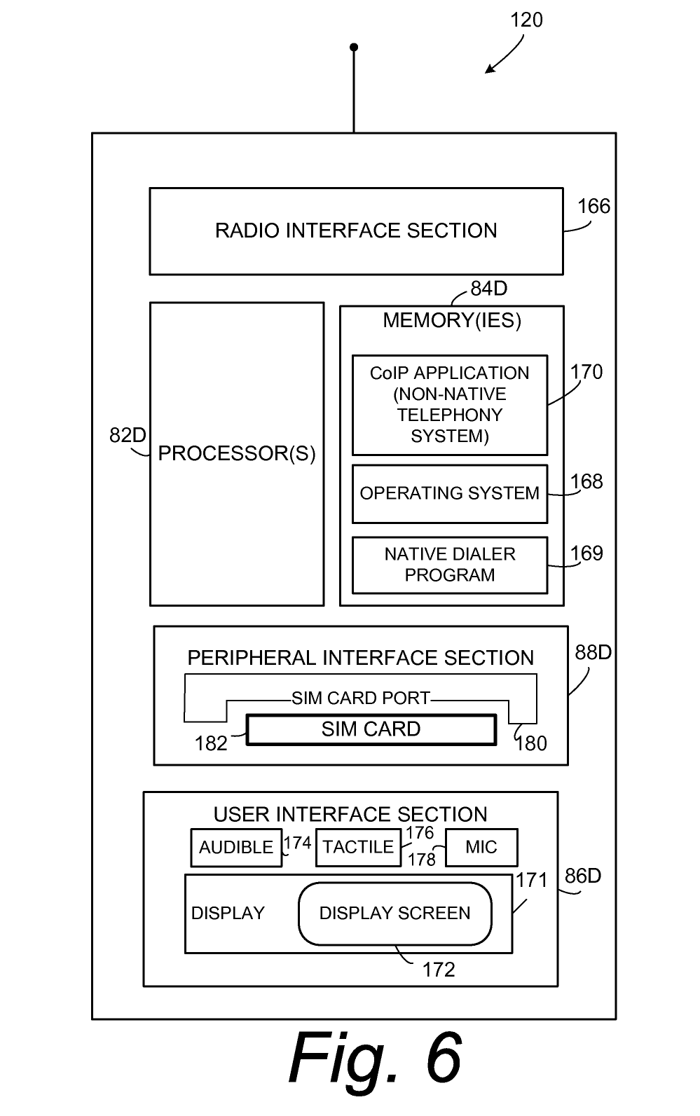

FIG. 6 shows general structural and functional components of telephony device 120 according to an example embodiment. The telephony device 120 of FIG. 6 includes radio interface section 166; user interface section 86D; peripheral interface section 88D; memory(ies) 84D; and processor(s) 82D.

Radio frequency section 166, also known as a radio frequency interface, is configured to enable telephony device 120 to communicate over radio frequencies, e.g., over an air or radio interface, with an appropriate communication node. As understood from FIG. 3, in some situations the communication node may be the wireless access point 150 through which the telephony device 120 participates in WiFi or WiMax type data communications, as a link in overall data communications with the IP telephony service 20. In other situations also understood from FIG. 3 the communication node may be a macro base station 146 through which the telephony device 120 participates in GPRS-type communications, as a link in overall data communications with the IP telephony service 20. The person skilled in the art will understand that radio frequency section 166 therefore includes appropriate transmitter(s) and receiver(s), as well as antenna(s), as well as radio frequency processing circuitry for pre-processing or post-processing of signals applied to or received from such transmitter(s) and receiver(s).

The memory(ies) 84D may comprise one or more different types of non-transient memories, including random access memory (RAM) and read only memory (ROM). As mentioned above, memory(ies) 84D may have stored therein instructions, in the form of programs or systems, which are executed by processor 82D. In other words, the programs or systems stored in memory(ies) 84D are, at appropriate times, loaded into instruction registers or the like of processor 82D and are executed by processor 82D. For example, telephony device operating system 168 is stored in memory(ies) 84D and executed by processor 82D, as is a native dialer program 169. The native dialer program 169 is executed by processors 82D when the telephony device 120 seeks to use the telephony system which is native to telephony device 120 (e.g., a telephone system other than IP telephony system 20). Another program stored in memory(ies) 84D and executed by processors 82D is CoIP application 170, described herein. The CoIP application 170 is an example of software 100 shown in FIG. 3.

The user interface 86D may comprise one or more different types of interface devices, and includes interface devices that are configured to facilitate interaction with a user. As shown in FIG. 6, among the interface devices that may comprise user interface 86D are display/touch screen 171 (which comprises display screen 172), audible output device 174 (speaker), tactile output device (e.g., haptic device) 176, and microphone 178.

As used herein, “display screen” refers to a portion of a display device on which content may be displayed, e.g., to the actual area of a display device wherein pixels or driven illustration elements are located and are visible. A “screen display”, on the other hand, refers to content that is actually rendered on the display screen as a result of execution of instructions that generate the screen display.

The processor 82D may comprise one or more processor(s) or controller(s) as elaborated herein and discussed further with respect to FIG. 2. The processor 82D executes various sets of instructions stored on non-transient computer-readable media. These sets of instructions may be stored in memory(ies) 84D. One of the sets of instructions comprises operating system 168 for telephony device 120. Other of the sets of instructions may comprise software programs, at least some of which are in the form of computerized executable applications (“apps”).

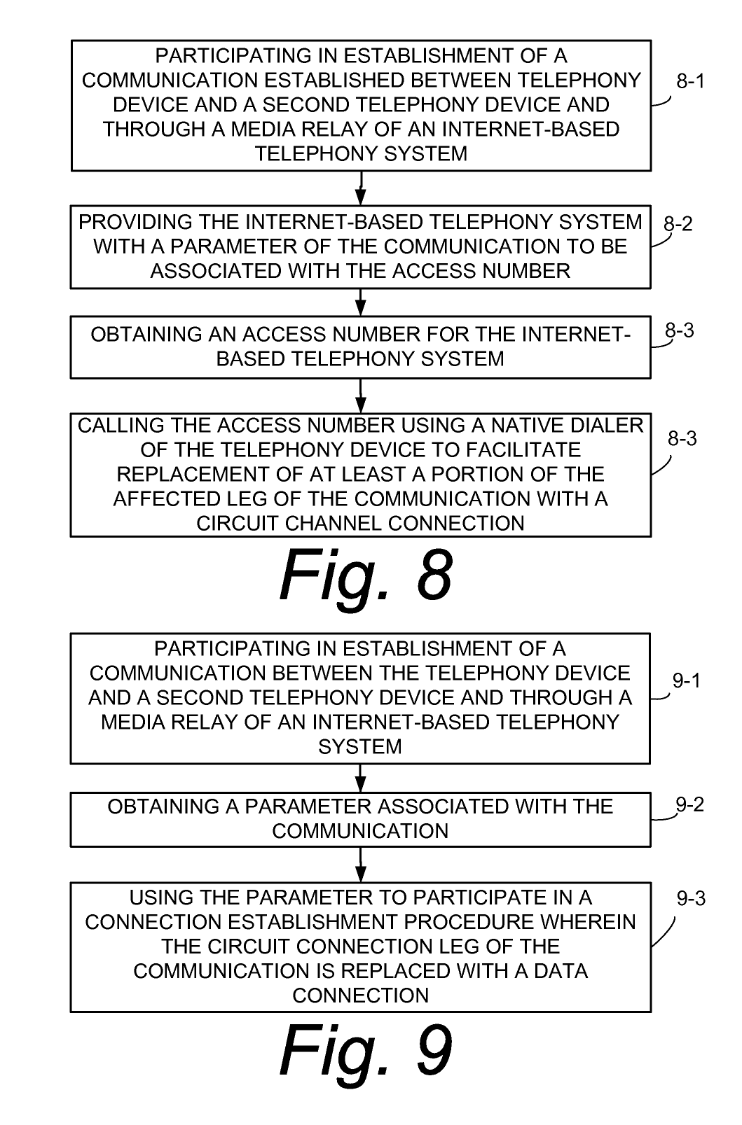

One such executable application may be an application provided by or designed to work in conjunction with communications sent or received by or routed through an internet-based telephony system 20, and thus may generically be termed a “network application” installed on the telephony device. Typically the internet-based telephony system 20 is not native to the telephony device. It was mentioned previously that the communications encompassed by the technology described herein are not limited to voice communications, and for that reason the internet-based telephony system 20 may also be referred to as a “Communication over IP”, or “CoIP system”. Accordingly, for the same reasons the network application executed by processor 82D of telephony device 120 may be referred to as the aforementioned “CoIP application” 170. As such, “CoIP” comprises but it not limited to VoIP communications. The CoIP application 170 may take the form of a computer software product (such as software 100 show in FIG. 2) comprising instructions stored on a non-transient memory which, when executed by processor 82D of telephony device 120, result in performance of the acts herein described (see, acts of FIG. 8 and FIG. 9).

A peripheral interface 88D of telephony device 120 comprises, e.g., SIM card port 180. As shown in FIG. 6 the SIM card port 180 accommodates Subscriber Identity Module (SIM) card 182.

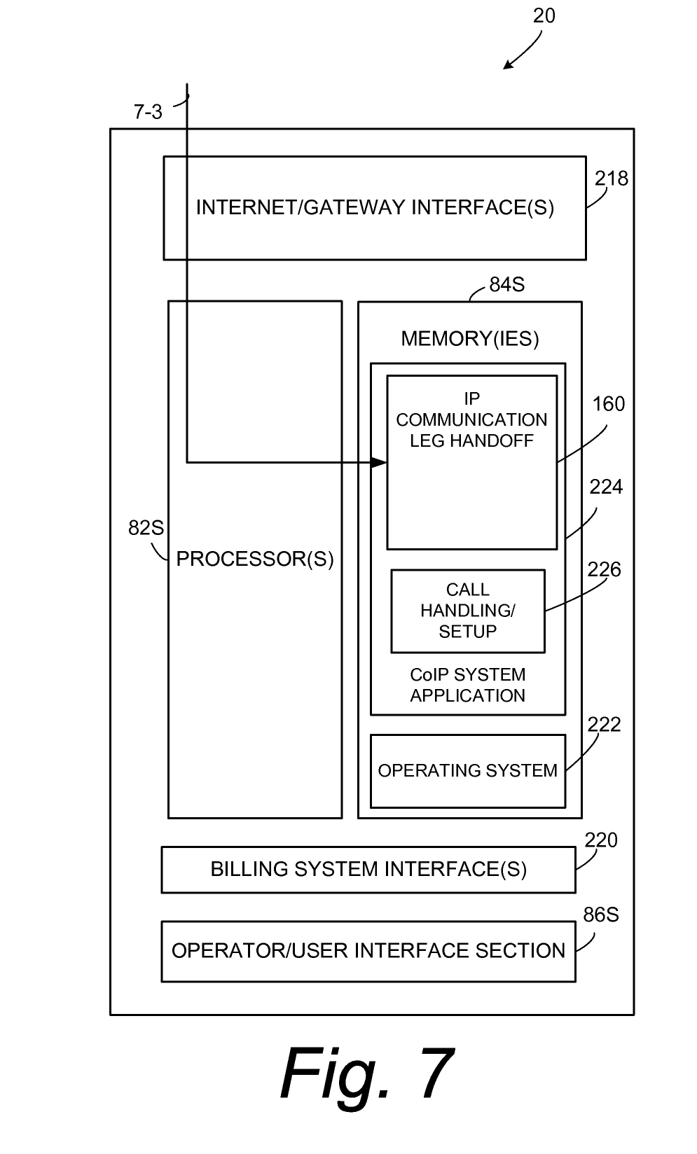

FIG. 7 shows selected basic aspects of IP telephony system 20 according to an example embodiment. Among the illustrated functionalities and units of IP telephony system 20 are processor(s) 82S, memory(ies) 84S, operator/user input/output interfaces 86S, internet/gateway interface(s) 218, and other interfaces 220 (such as billing system interfaces). As understood from FIG. 2 and the preceding discussion of the IP telephony system 20, the processors 82S of IP telephony system 20 execute coded instructions, including IP telephony system operating system 222 and CoIP System application 224. In executing CoIP System application 224, the processors 82S performs the function of IP communication leg handoff processor 160 for IP telephony system 20, among its other functions.

As mentioned above, FIG. 5 describes various general acts performed by IP communication leg handoff processor 160, including replacing a replaceable leg with a replacement leg (act 5-3). FIG. 4A illustrates various example implementation acts or steps which may be performed when the replaceable leg is a data channel leg and the replacement leg is a circuit channel leg. On the other hand, FIG. 4B illustrates various example implementation acts or steps which may be performed when the replaceable leg is a circuit channel leg and the replacement leg is a data channel leg. Some of the acts or steps of both FIG. 4A and FIG. 4B may be performed by IP communication leg handoff processor 160, while others of the acts or steps may be performed by the CoIP application 170 executing at the telephony device.

FIG. 4A shows the communications network comprising FIG. 4 and further shows example, representative implementation acts performed for handing off a communication leg from a data channel to a circuit channel. The acts may be depicted by or referred to as an “arrow”, and “act” and “arrow” may be used interchangeably for both FIG. 4A and FIG. 4B. Arrow 4A-1 and arrow 4A-2 essentially illustrate telephony device 120A (the calling party) initiating a CoIP communication (e.g., a VoIP call). Arrow 4A-1 represents signaling between telephony device 120A and SIP server 161 involved in setting up a first leg of communication. Arrow 4A-2 represents signaling between SIP server 161 and telephony device 120B involved in setting up a second leg of communication. The signaling of both arrow 4A-1 and arrow 4A-2 is preferably session initiation protocol (SIP) signaling, and is performed at least in part by the CoIP application 170 for the non-native IP telephony system 20 which is installed and executing on the telephony device 120. With the setup of the communication an identifier or “call ID” is allocated to the communication, and telephone numbers or identifiers will also be associated with telephony device 120A (identifier “A” or “A number”) and telephony device 120B (identifier “B” or “B number”).

Arrow 4A-3 comprises flow of media (e.g., a flow of real time protocol [RTP] packets) over a first data channel leg of the communication, with the arrow 4A-3 thus also representing the first data channel leg of the communication. Because the flow of media over the first data channel leg of the communication will, in FIG. 4A, be anticipated to be the replaceable leg, the first data channel leg (e.g., arrow 4A-3) is illustrated with dashed lines in FIG. 4A. Arrow 4A-4 comprises flow of media (e.g., a flow of real time protocol [RTP] packets) over a second data channel leg of the communication, with the arrow 4A-4 thus also representing the second data channel leg of the communication. The flow of media is described with respect to media relay 162, and particularly to ports of media relay 162. For example, the flow of packets over the first data channel leg of the communication (arrow 4A-3) connects to port 162A of media relay 162; the flow of packets over the second data channel leg of the communication (arrow 4A-4) connects to port 162B of media relay 162.

Arrow 4A-5 depicts the CoIP application 170 of telephony device 120A contacting provisioning server 163 to reserve an Access Number (AN) for the communication established by the signaling of act/arrow 4A-1 and act/arrow 4A-2. In conjunction with act 4A-5 the telephony device 120A sends to provisioning server 163 a signal that includes the call ID for the communication and the identifiers A and B (e.g., the “A number” and the “B number”) of the calling party telephony device 120A and the called party telephony device 120B, respectively. Act 4A-6 depicts the provisioning server 163 allocating and returning to telephony device 120A an Access Number (AN) to the communication. The Access Number (AN) is associated with a parameter of the communication (e.g., the call ID or the “A number”). The signaling of act 4A-5 and act 4A-6 may be any appropriate signaling protocol, such as session initiation protocol (SIP), for example.

The Access Number (AN) which is allocated or assigned by provisioning server 163 may be a telephone number assigned to IP telephony system 20 and through which the IP telephony system 20 may be contacted through the public switched telephone network (PSTN) 26. For example, the Access Number (AN) may be a phone number such as a ten digit number that is associated with IP telephony system 20. The IP telephony system 20 may own or be assigned a set of access numbers. When an access number belonging to the IP telephony system 20 is dialed, the call is directed to a specific server comprising gateway 32.

Act 4A-5 may be performed in parallel with establishment of the communication (e.g., acts 4A-1 and 4A-2), or essentially immediately thereafter. Moreover, the mapping between the Access Number (AN), Call ID, “A number”, and “B number”, is stored by provisioning server 163 in the communication parameter database 164, as depicted by act 4A-7 of FIG. 4A.

The communication between telephony device 120A and telephony device 120B over first leg (data channel of arrow 4A-3) and over the second leg (data channel of arrow 4A-4) continues until occurrence of a predetermined event. The communication between telephony device 120A and telephony device 120B involves flow of media between telephony device 120A and telephony device 120B and through the intermediate media relay 162 comprising IP telephony system 20. The predetermined event may comprise a network change or a low quality event (e.g., a low quality of service (QoS) value or other indication such as a predetermined error rate, predetermined number of packet retransmissions, or the like). The predetermined event may be detected by or reported to either telephony device 120A, telephony device 120B, or media relay 162.

In the scenario of FIG. 4A, the predetermined event is illustrated as event 4A-8, which is shown as affecting the first leg (data channel of arrow 4A-3) of the communication. As mentioned above, the event 4A-8 may be a loss of the data channel over which the first leg is carried, or a significantly lowered quality of the data channel. The predetermined event may be detected by either telephony device 120A or telephony device 120B. A telephony device such as telephony device 120A and telephony device 120B has a data network signal strength indicator provided to its CoIP application 170 via an application programmable interface of operating system 168. Should the data network signal strength indicator of telephony device 120A indicate a low data channel quality, the CoIP application 170 of telephony device 120A is notified via an application programmable interface of operating system 168.

The CoIP application 170, being executed at the telephony device 120A in conjunction with the communication, thus either detects or is informed of the occurrence of the predetermined event 4A-8. The CoIP application 170 may optionally advise or notify the user, via an output indication provided on one or more of input/output interfaces 86D, that the current communication needs to be re-established. For example, the CoIP application 170 may provide a visual or aural notification on display screen 172 that the communication is being re-established. In some embodiments, the reconnection of the communication may occur so rapidly that it may be not be necessary or desirable to notify the user.

Upon realizing the predetermined event 4A-8, the CoIP application 170 requests that the native dialer program 169 of telephony device 120A dial the Access Number (AN) for IP telephony system 20 that was obtained in act 4A-6. Act 4A-9 shows the native dialer program 169 dialing the Access Number (AN). The Access Number (AN) is shown as being an incoming line or port of PSTN gateway 32. Thus, in the embodiment and scenario of FIG. 4A, act 4A-9 serves as a connection-request message in the form of a circuit channel call to the Access Number (AN) at gateway 32 toward another telephone system (e.g., toward public switched telephone network (PSTN) 26).

Act 4A-10 shows that signaling for the call received from telephony device 120A (having the “A” number”) at the Access Number (AN) is converted from PSTN to session initiation protocol (SIP) and sent to SIP server 161. Knowing both the Access Number (AN) and the A number for the re-established call, SIP server 161 sends a signal to communication parameter database 164 to request that the communication parameter database 164 perform a lookup to find the call ID and the B number associated with the Access Number (AN) and the A number (which were stored in communication parameter database 164 as act 4A-7). The communication parameter database 164 then returns the call ID and the B number associated with the Access Number (AN) and the A number to SIP server 161. The operations of the SIP server 161 requesting and receiving the call ID and the B number from communication parameter database 164 are collectively represented as act 4A-11 in FIG. 4A.

Act 4A-12 comprises SIP server 161 contacting media relay 162 to arrange for replacement of the replaceable leg with the replacement leg. Specifically, as act 4A-12 the SIP server 161 provides media relay 162 with the call ID, A number, and B number for the communication, and requests that media relay 162 transfer the leg of the communication currently connected to the A number from media relay port 162A to a new port which is connected to PSTN gateway 32, such as port 162G. A system internal data leg is set up or utilized between media relay port 162G and the PSTN gateway 32 as shown by arrow 4A-13 for the media flow, it being understood that gateway 32 provides necessary PSTN signaling to telephony device 120A. As a result of the signaling between first telephony device 120A and PSTN gateway 32, a replacement leg 4A-14, a first circuit channel leg of the communication, extends from gateway 32 to telephony device 120A. As a result, the media flow of the communication travels through the replacement first circuit channel leg 4A-14 (instead of through first data channel leg 4A-3) to PSTN gateway 32 where the media is converted to RTP or other appropriate data format, through system internal data leg 4A-13 to port 162G of media relay 162, through media relay 162, and from port 162B of media relay through the second data channel leg 4A-4 to second telephony device 120B. Thus, the media flow may experience circuit-to-packet conversion at PSTN gateway 32.

As understood from the foregoing, upon the SIP server 161 obtaining the parameter associated with the communication (the call ID and the B number associated with the Access Number (AN) and the A number), the SIP server 161 causes the media relay 162 to route media for the communication through the gateway 32 and replacement leg 4A-14 in lieu of routing the media through at least a portion of the replaced first data leg 4A-3.

From the foregoing it is also seen that the IP telephony system 20, and particularly the IP communication leg handoff processor 160, performs the acts of FIG. 5A. Act 5A-1 comprises associating an access number for the internet-based telephony system with a parameter of the communication (as performed by provisioning server 163). Act 5A-2 comprises obtaining the parameter associated with the communication (e.g., performed by SIP server 161 obtaining the parameter from communication parameter database 164). Act 5A-3 comprises routing media for the communication through the gateway in lieu of routing the media through at least a portion of a replaced one of the first data leg of the communication and the second data leg of the communication.

FIG. 4B illustrates various example implementation acts or steps which may be performed when the replaceable leg is a circuit channel leg and the replacement leg is a data channel leg. FIG. 4B depicts a situation in which telephony device 120A (the calling party) initiates a communication with telephony device 120B (the called party). Act 4B-1 shows the telephony device 120A using signaling for setting up a first leg of the communication as a circuit channel leg. The native dialer program 169 of the telephony device 120A may be commissioned or permitted by CoIP application 170 to set up the first circuit channel leg. In this regard, the CoIP application 170 may provide native dialer program 169 with one or more access numbers by which the IP telephony system 20 may be reachable through public switched telephone network (PSTN) 26. The signaling through which the PSTN 26 sets up the first leg of the communication as a circuit channel leg is routed or directed to PSTN gateway 32, where such PSTN signaling is converted or otherwise used to generate SIP signaling for the call. Act 4B-1′ shows the SIP signaling for the call setup involving telephony device 120A is routed to SIP server 161. Upon receipt of the call setup signaling from telephony device 120A, the SIP server 161 performs further signaling with the called party at telephony device 120B, as depicted by act 4B-2. In addition, as indicated by arrow 4B-3 the SIP server 161 informs media relay 162 that the communication being set up for first telephony device 120A will involve media flow through PSTN gateway 32, so that media of the communication may flow from an appropriate port of media relay 162 (such as port 162G) to PSTN gateway 32.

Upon completion of the call set up signaling, a media flow for the communication comprising a first circuit channel leg of the communication (depicted by arrow 4B-3) and a second data channel leg of the communication (depicted by arrow 4B-4) is established. In particular, the media flow comprises the first circuit channel leg 4B-3 (which extends from telephony device 120A to PSTN gateway 32); an intra-system data leg depicted by arrow 4B-4 which extends from PSTN gateway 32 to port 162G of media relay 162; a cross connect between port 162G and port 162B; and second data channel leg 4B-6 extending from port 162B of media relay 162 to telephony device 120B. Because this first circuit channel leg 4B-3 will be a replaceable leg of the communication, the arrow for first circuit channel leg 4B-3 is shown with dashed lines. The media flow continues as illustrated until occurrence of a predetermined event. The media flow may undergo circuit channel to data channel conversion at PSTN gateway 32.

It should be understood that FIG. 4B may reflect a scenario in which the calling party at telephony device 120A has initiated a call in which the first leg is a circuit channel leg. Alternatively, FIG. 4B may also illustrate a scenario in which, after initiation of the communication, the first leg has become a circuit channel leg, for example, in accordance with the acts described in FIGS. 4A and 5A.

Act 4B-6 of FIG. 4B depicts the occurrence of a predetermined event. In the same manner as explained above, the predetermined event may comprise degraded or poor quality of a channel, or even loss or perceived absence of a channel. Alternatively or additionally, the predetermined event may comprise a determination that a data channel is available to replace a circuit channel, e.g., that the telephony device 120A may be able to change from a circuit network to a data network. In the scenario of FIG. 4B, the predetermined event 4B-6 affects the first circuit channel leg 4B-3. The predetermined event 4B-6 may be detected by, or reported to, telephony device 120A.

The CoIP application 170 of the telephony device 120A may determine that a data network is available in lieu of the circuit network (e.g., public switched telephone network (PSTN) 26) that has been used to handle the first circuit channel leg of the communication. Upon such determination of availability of a data network, the CoIP application 170 of telephony device 120A may, as act 4B-7, call the provisioning server 163 of IP telephony system 20. The call of act 4B-7 to provisioning server 163 is configured to request that the provisioning server 163 obtain and send to CoIP application 170 the internal call ID for the communication. The call of act 4B-7 may use Hypertext Transfer Protocol (HTTP), for example. Since, at least in one example scenario, the communication started or was initiated through the public switched telephone network (PSTN) 26, the CoIP application 170 may not have been informed of the call ID. But telephony device 120A, and thus CoIP application 170, knows the A number and the B number at the time of call initiation. The A number and B number are stored for every call, along with the associated call ID, in database 164. So upon receipt of the call of act 4B-7 including the A number and the B number the provisioning server 163 of IP telephony system 20 can query the database 164, obtain the needed call ID, and return the call ID to telephony device 120A and its CoIP application 170. Act 4B-8 of FIG. 4B reflects the provisioning server 163 providing the CoIP application 170 with the call ID for the communication.

The foregoing describes that telephony device 120A may become a data network-eligible telephony device, e.g., a data network is available and utilizable by telephony device 120A in lieu of the circuit network. Upon becoming a data network-eligible telephony device, the telephony device 120A is provided (by provisioning server 163) with a parameter associated with the communication, e.g., the call ID.

Upon determining that a data network is available, the CoIP application 170 of telephony device 120A may optionally inform or notify the user of telephony device 120A that the CoIP application 170 is attempting or will attempt to re-establish the communication (e.g., over a data network). In some situations the re-establishment may occur so quickly that it may be unnecessary or even undesirable to notify the user.

Also after determining that a data network is available, as act 4B-9 the CoIP application 170 sends a connection request message to SIP server 161. The connection request message of act 4B-9 may be a SIP INVITE or SIP RE-INVITE message. The connection request message of act 4B-9 includes the call ID, the A number (of telephony device 120A), and the B number (of telephony device 120B).

As act 4B-10 the SIP server 161 contacts media relay 162 in conjunction with the communication that is associated with the call ID, number A, and number B borne by the connection request message of act 4B-9. As part of act 4B-10 the SIP server 161 directs the media relay 162 to transfer the media flow of the communication from port 162G to another port, such as port 162A, which may be used for a data channel. With the transfer from port 162G to port 160A, the media flow of the communication occurs through the replacement first data leg (depicted by arrow 4B-11), between ports 162A and 162B internally in media relay 162, and through the second data leg of the communication (depicted by arrow 4B-4). The second data leg of the communication (depicted by arrow 4B-4) extends between port 162B and telephony device 120B.

It was described above how in the scenario of FIG. 4B the predetermined event 4B-6 affects the first circuit channel leg 4B-3, as detected by, or reported to, telephony device 120A. It should be understood that acts of the scenario of FIG. 4B could also occur in various ways, including a mirror image of FIG. 4B. That is, should the leg 4B-4 be a circuit channel leg and a predetermined event comparable to event 4B-6 occur on circuit channel leg 4B-4, the predetermined event on the leg 4B-4 would be detected by, or reported to, telephony device 120B. Thereafter acts comparable to FIG. 4B would then be performed so that leg 4B-4 is replaced with a data leg.

From the foregoing it is seen that the IP telephony system 20, and particularly the IP communication leg handoff processor 160, performs the acts of FIG. 5B. The acts of FIG. 5B are performed upon whichever of the first telephony device and the second telephony device is connected to the internet-based telephony system through the circuit connection leg becoming a data network-eligible telephony device. Act 5B-1 comprises providing the data network-eligible telephony device with a parameter associated with the communication, e.g., the call ID as obtained from the provisioning server 163. Act 5B-2 comprises, upon receiving the connection-request message from the data network-eligible telephony device (e.g., act 4B-9 of FIG. 4B), replacing the circuit channel leg (e.g., leg 4B-3) with a data channel leg (e.g., leg 4B-11) between the data network-eligible telephony device and the internet-based telephony system.

It was mentioned above that some of the acts of FIG. 4A and FIG. 4B may be performed by IP communication leg handoff processor 160 of IP telephony system 20, and other acts may be performed by processors 82D upon executing CoIP application 170.

FIG. 8 illustrates various example, representative acts or steps that may be performed by processors 82D of telephony device 120A upon executing CoIP application 170 in conjunction with the data-to-circuit handoff of a leg of a communication illustrated in FIG. 4A, for example.

Act 8-1 comprises a processor of a telephony device, e.g., processors 82D of telephony device 120A, participating in establishment of a communication between telephony device and a second telephony device and through a media relay 162 of an internet-based telephony system 20. As explained above, the internet-based telephony system 20 is not a native telephony system of the telephony device. The communication as established at least initially comprises a first data leg of the communication (such as arrow 4A-3) and a second data leg of the communication (such as arrow 4A-4). As shown in FIG. 4A, the first data leg 4A-3 of the communication exists between the telephony device 120A and the internet-based telephony system 20 and the second data leg 4A-4 of the communication exists between the second telephony device 120B and the internet-based telephony system 20. The processors 82D participating in the establishment of the communication may comprise participating in the communication setup signaling as depicted by act 4A-1.

Act 8-2 comprises the processor 82D of the telephony device 120A providing the internet-based telephony system 20 with a parameter of the communication to be associated with the access number. Act 8-2 is also illustrated with reference to act 4A-5 of FIG. 4A. Act 8-3 comprises the processor 82D of the telephony device 120A obtaining an access number (AN) for the internet-based telephony system 20. Act 8-3 is also illustrated with reference to act 4A-6 of FIG. 4A (in which the Access Number (AN) is obtained from provisioning server 163).

Act 8-4 occurs upon occurrence of a predetermined event involving an affected leg of the communication, e.g., leg 4A-3 of FIG. 4A. As explained previously, the predetermined event may comprise a network change or a low quality event. Act 8-4 comprises the processor 82D calling the access number (e.g., using a native dialer of the telephony device) to facilitate replacement of at least a portion of the affected leg of the communication with a circuit channel connection. Act 8-4 is thus also illustrated by act 4A-9 of FIG. 4A. The affected leg of the communication being may be either the first leg of the communication (e.g., leg 4A-3 as is the case in the illustration of FIG. 4A), or the second leg of the communication (e.g., leg 4A-4).

The acts of FIG. 8 thus may be performed as the processor 82D executes the Communications over Internet Protocol (CoIP) application 170 for the internet-based telephony system. The Communications over Internet Protocol (CoIP) application 170 is stored on non-transient computer-readable medium and comprising instructions which are executable by the processor.

FIG. 9 illustrates various example, representative acts or steps that may be performed by processors 82D upon executing CoIP application 170 in conjunction with the circuit-to-data handoff of a leg of a communication illustrated in FIG. 4B.

Act 9-1 comprises the processors 82D participating in establishment of a communication between the telephony device 120A and a second telephony device 120B and through the media relay 162 of internet-based telephony system 20. As explained above, internet-based telephony system 20 is not a native telephony system of the telephony device 120A. As established, the communication at least initially comprising a first leg of the communication (shown as leg 4B-3 in FIG. 4B) and a second data leg of the communication (shown as leg 4B-4 in FIG. 4B). The first leg 4B-3 of the communication exists between the telephony device 120A and the internet-based telephony system 20; the second leg 4B-4 of the communication exists between the second telephony device 120B and the internet-based telephony system 20. The first leg 4B-3 of the communication is at least partially carried by a circuit channel. The act 9-1 may comprise the processors 82D sending the connection signaling of act 4B-1 as shown in FIG. 4B.

In the method of FIG. 9 the telephony device becomes a data network-eligible telephony device. Such may occur, as explained above, by the telephony device 120A determining that a data channel is available to replace the circuit channel employed for the first circuit channel leg 4B-3. Act 9-2 comprises the processors 82D of the telephony device 120D obtaining a parameter associated with the communication. Act 9-2 may also be depicted as act 4B-7, wherein the telephony device 120A obtains the call ID for the communication from provisioning server 163.

Act 9-3 comprises the processors 82D of the telephony device 120D using the parameter to participate in a connection establishment procedure wherein the circuit channel leg of the communication (e.g., leg 4B-3) is replaced with a data channel leg, e.g., replacement data channel 4B-11).

As is also understood with reference to act 4B-9 of FIG. 4B, the processors 82D may also send a connection request message which includes the parameter (e.g., call ID) to the internet-based telephony system 20. The connection request message of act 4B-9 may be a SIP INVITE or SIP RE-INVITE message.

Thus the acts of FIG. 9 may be performed as processor 82D executes Communications over Internet Protocol (CoIP) application 170 for the internet-based telephony system. As mentioned before, the Communications over Internet Protocol (CoIP) application 170 is stored on non-transient computer-readable medium and comprising instructions which are executable by the processor.

Although the data-to-circuit leg handover operation of FIG. 4A and the circuit-to-data leg handover operation of FIG. 4B have been described separately, it should be understood that at least in some example embodiments and modes a data-to-circuit leg handover operation/scenario may follow a circuit-to-data leg handover operation/scenario, or a circuit-to-data leg handover operation/scenario may follow a data-to-circuit leg handover operation/scenario. Sequential handovers may be performed as the telephony device roams (e.g., with different networks becoming or not becoming available), or as network conditions change for other reasons.

The CoIP application 170 as described above may take various implementation forms. For example, the CoIP application 170 may be configured and executed as a traditional “over the top” (OTT) application. An OTT application typically executes separately from the native dialer program 169. In its OTT form the CoIP application 170 may authorize the native dialer program 169 to re-establish the communication by placing a call through the public switched telephone network (PSTN) 26 to the Access Number, as described in conjunction with act 4A-9. But an OTT version of CoIP application 170 may not be able to assume control back from the native dialer program 169 after a circuit channel leg has replaced a data channel leg since the OTT version of CoIP application 170 may not have permission to do so. Therefore, with an OTT CoIP application 170 it may not be possible after a circuit-to-data switch of a leg to revert back to by data leg by performing a subsequent data-to-circuit switch.

In some implementations the CoIP application 170 may take the form of a mobile virtual network operator (MVNO) application. An MVNO CoIP application 170 may be essentially one-in-the-same with the native dialer program 169, or have interface capabilities that the operating system and/or the native dialer program 169 so that the MVNO CoIP application 170 may reassume or continue in control even after a connection request has been made for a circuit channel through public switched telephone network (PSTN) 26, for example. Thus, with a MVNO CoIP application 170 it may indeed be possible after a circuit-to-data switch of a leg to revert back to by data leg by performing a subsequent data-to-circuit switch.

It was mentioned above that the telephony device 120A may become a data network eligible telephony device, and that such eligibility may comprise the predetermined event that triggers replacement of the replaceable leg of the communication with the replacement leg. Eligibility as a data network eligible telephony device may occur as the telephony device 120A roams from a circuit network to a data network. It is understood by those skilled in the art that a telephony device may roam in various manners or scenarios, including but not limited to those described in U.S. patent application Ser. No. 14/291,566, filed May 30, 2014; and U.S. patent application Ser. No. 14/333,490, filed Jul. 16, 2014, both of which are incorporated herein by reference in their entireties.

Various functions described herein, including functions of IP communication leg handoff processor 160 of internet-based telephony system 20 and IP telephony application 170 of telephony device 120, may, at least in some embodiments and modes, be performed by machine hardware such as that shown in FIG. 2. Software routines such as software for roaming of telephony system 20 and the software (e.g., IP telephony application 170) for the telephony device 120 are executed by processor(s) 82S of the internet-based telephony system 20 and processor(s) 82D of telephony device 120, respectively. For the machine hardware of each processor such software may be stored on non-transient memory such as program instruction memory. Also, the software routines could also be stored remotely from the CPU, e.g., remotely from processors 82. For example, the software could be resident on servers and memory devices that are located remotely from the CPU, but which are accessible to the CPU via a data network connection.

The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented, and thus machine-implemented.

In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) [ASIC], and/or field programmable gate array(s) (FPGA(s)), and (where appropriate) state machines capable of performing such functions.

In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” shall also be construed to refer to other hardware capable of performing such functions and/or executing software, such as the example hardware recited above.

Although the description above contains many specificities, these should not be construed as limiting the scope of the technology disclosed herein but as merely providing illustrations of some of the presently preferred embodiments of the technology disclosed herein. Thus the scope of the technology disclosed herein should be determined by the appended claims and their legal equivalents. Therefore, it will be appreciated that the scope of the technology disclosed herein fully encompasses other embodiments which may become obvious to those skilled in the art, and that the scope of the technology disclosed herein is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the technology disclosed herein, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A method of operating an internet-based telephony system comprising:
establishing a communication between a first telephony device and a second telephony device through the internet-based telephony system, the communication at least initially comprising a first leg of the communication and a second leg of the communication, the first leg of the communication existing between the first telephony device and the internet-based telephony system and the second leg of the communication existing between the second telephony device and the internet-based telephony system;
receiving a connection-request message from the first telephony device; and, as a result thereof
at least partially replacing a replaceable leg with a replacement leg having a different channel type than the replaceable leg, the replaceable leg being one of the first leg of the communication and the second leg of the communication, the different channel type being either a data channel or a circuit channel.

2. The method of claim 1, wherein the first leg of the communication is a first data leg and the second leg is a second data leg, the method further comprising:
associating an access number for the internet-based telephony system with a parameter of the communication;
receiving a circuit channel call to the access number as the connection-request message;
obtaining the parameter associated with the communication; and
routing media for the communication through the replacement leg in lieu of routing the media through the replaceable leg.

3. The method of claim 2, further comprising:
establishing the communication between the first telephony device and the second telephony device through a media relay of the internet-based telephony system; and
upon receiving the circuit channel call to the access number at a gateway of the internet-based telephony system, routing the media for the communication between the gateway and the media relay in lieu of routing the media through the replaceable leg.

4. The method of claim 3, wherein upon receiving the circuit channel call to the access number at the gateway the internet-based telephony system routes media for the communication (1) between the gateway and the media relay so that the communication is at least partially carried through the circuit channel and (2) through a non-replaced one of the first data leg of the communication and the second data leg of the communication so that the communication is at least partially carried by a data channel between the media relay and one of the telephony device and the second telephony device.

5. The method of claim 2, wherein the parameter comprises a call identifier of the communication.

6. The method of claim 2, wherein the parameter comprises an identifier associated with the telephony device.

7. The method of claim 2, wherein the parameter comprises an identifier associated with the second telephony device.

8. The method of claim 2, wherein associating the access number for the internet-based telephony system with the parameter occurs before a predetermined event and receiving the circuit channel call occurs after the predetermined event, the predetermined event comprises a network change or a low quality event.

9. The method of claim 1, wherein at least one of the first leg and the second leg is a circuit channel leg which is at least partially carried by a circuit channel, the method further comprising:
upon whichever of the first telephony device and the second telephony device is connected to the internet-based telephony system through the circuit channel leg gaining access to a data network and thus becoming a data network-eligible telephony device, providing the data network-eligible telephony device with a parameter associated with the communication;
upon receiving the connection-request message from the data network-eligible telephony device, replacing the circuit channel leg with a data channel leg between the data network-eligible telephony device and the internet-based telephony system.

10. The method of claim 9, further comprising:
establishing the communication between the first telephony device and the second telephony device through a media relay of the internet-based telephony system; and
upon receiving the connection-request message from the data network-eligible telephony device, routing the media for the communication through the data channel and the media relay.

11. The method of claim 9, wherein the connection-request message is a SIP INVITE or SIP RE-INVITE message which includes a call identifier.

12. The method of claim 9, wherein the connection-request message is a SIP INVITE or SIP RE-INVITE message which includes an identifier of the first telephony device.

13. The method of claim 9, wherein the connection-request message is a SIP INVITE or SIP RE-INVITE message which includes an identifier of the second telephony device.

14. An internet-based telephony system comprising a processor configured to:
establish a communication between a first telephony device and a second telephony device through the internet-based telephony system, the communication at least initially comprising a first leg of the communication and a second leg of the communication, the first leg of the communication existing between the first telephony device and the internet-based telephony system and the second leg of the communication existing between the second telephony device and the internet-based telephony system;
receive a connection-request message from the first telephony device; and as a result thereof
replace a replaceable leg with a replacement leg having a different channel type than the replaceable leg, the replaceable leg being one of the first leg of the communication and the second leg of the communication, the different channel type being either a data channel or a circuit channel.

15. The system of claim 14, wherein the first leg of the communication is a first data leg and the second leg is a second data leg, and the processor is further configured to associate an access number for the internet-based telephony system with a parameter of the communication;
wherein the connection-request message is a circuit channel call to the access number, and wherein upon receiving the circuit channel call the processor is further configured to:
obtain the parameter associated with the communication; and
route media for the communication through the replacement leg in lieu of routing the media through the replaceable leg.

16. The system of claim 15, wherein the processor is further configured to:
establish the communication between the first telephony device and the second telephony device through a media relay of the internet-based telephony system; and
upon receiving the circuit channel call to the access number at a gateway of the internet-based telephony system, route the media for the communication between the gateway and the media relay in lieu of routing the media through the replaceable leg.

17. The method of claim 16, wherein upon receiving the circuit channel call to the access number at the gateway the processor is configured to route media for the communication (1) between the gateway and the media relay so that the communication is at least partially carried through the circuit channel and (2) through a non-replaced one of the first data leg of the communication and the second data leg of the communication so that the communication is at least partially carried by a data channel between the media relay and one of the telephony device and the second telephony device.

18. The system of claim 15, wherein the parameter comprises a call identifier of the communication.

19. The system of claim 15, wherein the parameter comprises an identifier associated with the telephony device.

20. The system of claim 15, wherein the parameter comprises an identifier associated with the second telephony device.

21. The system of claim 15, wherein the processor is configured to associate the access number for the internet-based telephony system with the parameter occurs before a predetermined event and to receive the circuit channel call after the predetermined event, the predetermined event comprises a network change or a low quality event.

22. The system of claim 14, wherein at least one of the first leg and the second leg is a circuit channel leg which is at least partially carried by a circuit channel, and wherein the processor is further configured to:
upon whichever of the first telephony device and the second telephony device is connected to the internet-based telephony system through the circuit channel leg gaining access to a data network and thus becoming a data network-eligible telephony device, provide the data network-eligible telephony device with a parameter associated with the communication;
upon receiving the connection-request message from the data network-eligible telephony device, replace the circuit channel leg with a data channel between the data network-eligible telephony device and the internet-based telephony system.

23. The system of claim 22, wherein the processor is further configured to:
establish the communication between the first telephony device and the second telephony device through a media relay of the internet-based telephony system; and
upon receiving the connection-request message from the data network-eligible telephony device, route the media for the communication through the data channel and the media relay.

24. The system of claim 22, wherein the connection-request message is a SIP INVITE or SIP RE-INVITE message which includes a call identifier.

25. The system of claim 22, wherein the connection-request message is a SIP INVITE or SIP RE-INVITE message which includes an identifier of the first telephony device.

26. The system of claim 22, wherein the connection-request message is a SIP INVITE or SIP RE-INVITE message which includes an identifier of the second telephony device.
